(19) United States
(12) Patent Application Publication
(10) Pub. No.: US 2008/0055311 A1
(43) Pub. Date: Mar. 6, 2008

(54) PORTABLE DEVICE WITH RUN-TIME BASED RENDERING QUALITY CONTROL AND METHOD THEREOF

(75) Inventors: Milivoje Aleksic, Richmond Hill (CA); Aris Balatsos, Toronto (CA); Kevin O'Neil, Toronto (CA)

Correspondence Address: ADVANCED MICRO DEVICES, INC.;C/O VEDDER PRICE KAUFMAN & KAMMHOLZ, P.C., 222 N.LASALLE STREET, CHICAGO, IL, 60601, US

(73) Assignee: ATI Technologies Inc., Markham (CA)

(21) Appl. No.: 11/469,301

(22) Filed: Aug. 31, 2006

(51) Int. Cl. G06T 17/00

(52) U.S. Cl. 345/428

(57) ABSTRACT

A device includes a controller that is operative to dynamically control rendering quality of an output image when the device is in a reduced power mode based on data representing a desired runtime length of an application. Memory containing data representing quality of rendering control information may be utilized by the controller to control graphics processing circuitry to change a quality of graphics rendering based on the quality of rendering control information. The quality of control information may include, by way of example, and not limitation, data representing a number of vertices per object to use for rendering objects, a texture size to use per frame, a degree or type of anti-aliasing to employ, whether to use alpha blending, a tessellation level to employ, and playback frame rate information. A user interface may be employed that provides a selectable desired application runtime duration setting that is used when the device or portion of the device is in a low power mode. The controller uses the quality of rendering control information to dynamically control the rendering quality based on the selected desired application runtime duration set through the user interface.

### FIELD OF THE DISCLOSURE

The disclosure relates generally to devices having batteries, and more particularly to battery powered devices that employ power saving management operations.

### BACKGROUND OF THE DISCLOSURE

Portable devices, such as digital audio and/or video players, cell phones, cameras, camcorders, or any other suitable portable devices, have limited battery capacity. When the capacity of a battery drops below a threshold, known portable devices can operate in a low battery condition and reduce power consumption such as by, for example, dimming displays. In addition, low battery power modes can result in the shutting down of certain features of the device at varying levels of operation. For example, integrated circuits are known to go into low power states when a battery level has reached a low battery threshold level. Clock frequencies and voltages to certain functional blocks within the integrated circuit or the entire integrated circuit may be put in a low power mode. This may be carried out, for example, by varying clock frequencies to various circuits and lowering supply voltages to various internal circuits to an integrated circuit, such as an application specific integrated circuit, general purpose processor, baseband processor or any other circuit as desired. However, users may be mot concerned with the amount of play time of a digital audio or video playing device.

In addition, portable devices are known that have many different software applications and features, such as the ability to play games, play digital media, have cameras, camcorder functionality, email applications, voice communication capabilities, and other features. However, each feature can consume differing amounts of power and may have a different metric that is important for the given application or feature. Playing games and playing media streams in battery powered devices can consume large amounts of power resulting in the necessity of the user to recharge or switch batteries. When using a feature that requires the rendering of graphics information, such as playing a game on a portable device, the amount of time to play the game (e.g., the run-time length) may be an important metric to a user. Known devices may allow a user to set a threshold of remaining battery capacity so that when the battery capacity reaches the minimum level set, certain power reduction operations take place in an effort to save battery power. While these techniques help conserve battery capacity, they may not be sufficient in all cases. Some users may be more concerned with the available features and less concerned with the battery condition.

Therefore, a need exists for an improved power management operation in portable devices and/or portable wireless devices.

### BRIEF DESCRIPTION OF THE DRAWINGS

The invention will be more readily understood in view of the following description when accompanied by the below figures and wherein like reference numerals represent like elements:

FIG. 1 is a block diagram illustrating one example of a system employing a wireless portable device in accordance with one embodiment of the invention;

FIG. 2 is a block diagram illustrating one example of a portable device in accordance with one embodiment of the invention;

FIG. 3 is a flowchart illustrating one example of a method for dynamically controlling a rendering quality of images on a portable device in accordance with one embodiment of the invention;

FIG. 4 is a block diagram illustrating one example of a portion of a portable device in accordance with one embodiment of the invention;

FIG. 5 is a diagram illustrating one example of a graphic user interface in accordance with one embodiment of the invention;

FIG. 6 is a flowchart illustrating one example of a method for dynamically controlling a rendering quality of a portable device in accordance with one embodiment of the invention;

FIG. 7 is a diagram illustrating one example of a quality of rendering control lookup table based on selected quality of rendering controls set through a graphic user interface in accordance with one embodiment of the invention;

FIG. 8 illustrates one example of quality of rendering control information that may be employed, for example, by a driver application to set quality of rendering levels for an application that employs graphics rendering in accordance with one embodiment of the invention; and

FIG. 9 is a diagram illustrating maximum quality energy consumption curves and maximum runtime energy consumption curves.

### DETAILED DESCRIPTION OF THE DISCLOSURE

Briefly, in one embodiment, a device includes a controller that is operative to dynamically control rendering quality of an output image when the device is in a reduced power mode based on data representing a desired runtime length of an application. Memory containing data representing quality of rendering control information may be utilized by the controller to control graphics processing circuitry to change a quality of graphics rendering based on the quality of rendering control information. The data representing the quality of control information may include, by way of example, and not limitation, data representing a number of vertices per object to use for rendering objects, a texture size to use per frame, a degree or type of anti-aliasing to employ, whether to use alpha blending, a tessellation level to employ, and playback frame rate information. A user interface may be employed that provides a selectable desired application runtime duration setting that is used when the device or portion of the device is in a low power mode. The controller uses the quality of rendering control information to dynamically control the rendering quality based on the selected desired application runtime duration set through the user interface.

Also in one example, the device includes a battery and a power management module such as the controller executing executable code, to provide remaining battery capacity information to an executing application along with data indicating which power savings mode the device is in. For example, if the application is a game, the game may be a power aware game and the game application may then include a plurality of executable code segments that are alternatively executed to change a quality of rendering based on the remaining battery capacity information and the power savings mode information. In an alternative embodiment, a driver executing on the controller (or other processor) may utilize the rendering quality control information to control the graphics processing circuitry.

In another embodiment, the controller predicts an amount of power that the application (such as a game) will consume and controls the quality of rendering to match the desired runtime length of the application that was set by the user or otherwise provided. Corresponding methods are also described.

In addition, a network element is disclosed, such as a network server that may be for example, in wireless communication with the device, that receives a battery level indication or remaining battery capacity information from the wireless device and in response, provides the quality of rendering control information back to the wireless device. With this embodiment, the wireless remote device need not maintain storage of the quality of rendering control information for different levels of rendering quality or utilize portable device processing power to determine the quality of rendering control information. Other advantages will be recognized by one of ordinary skill in the art.

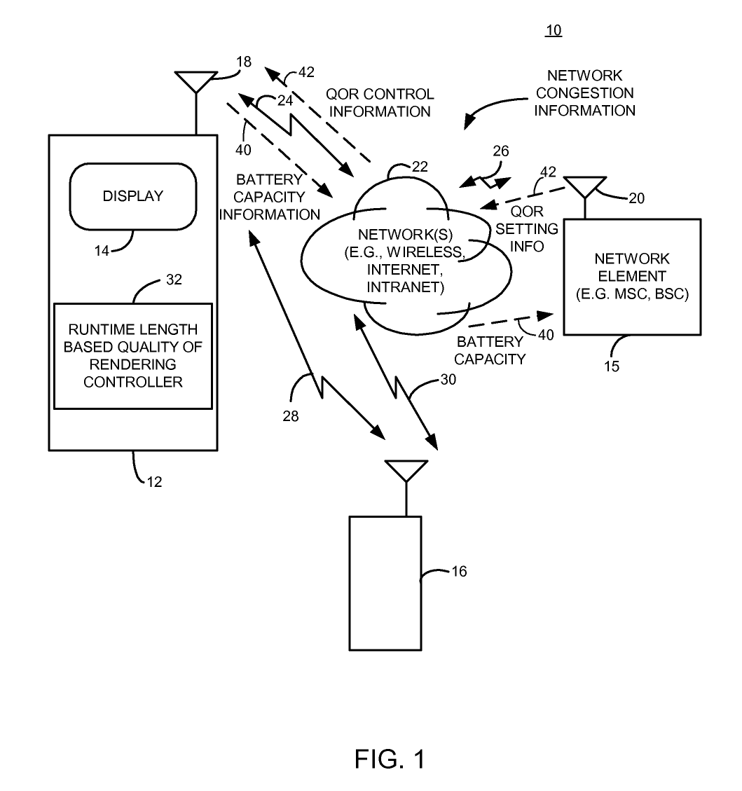

FIG. 1 illustrates one example of a system 10 that employs a portable device 12, in this case a wireless portable device, that communicates through suitable network communications with one or more network elements 15 and other portable devices 16, if desired. For purposes of illustration only and not limitation, the system will be described as a wireless communication system, such as a wireless cellular communication system that can communicate with web servers, if desired, but may be any other suitable communication network or combination of communication networks as desired. In addition, the portable device 12 will be described, in this example, as a wireless portable device such as, but not limited to, a wireless cell phone with any suitable features, a wireless digital audio and/or video player, a laptop computing device, an email communication device, or any other suitable portable device that utilizes, for example, a battery. For purposes of illustration only, the portable device 12 will be described herein as a cell phone having suitable features such as voice communication features using known cell phone communication circuits, camera features, digital audio storage and playback features, video storage and playback features, email features, and any other suitable features as desired.

As shown, the portable device 12 includes a display 14 and an antenna 18 for wirelessly communicating with the wireless network element 15, such as a base station, base site controller, or any other suitable network element. The network element 15 may be, for example, a server or group of servers that, as known in the art, employ one a network interface (e.g., wireless or non-wireless) to communicate with other network elements, one or more processors and associated memory and any suitable interfaces or circuits to communicate the information described herein. Although the network element 15 is shown as having an antenna 20 it will be understood that the network element 15 may be a group of elements that communicate with one another and that the antenna 20 may be part of a base station, for example, and another part of the network element 15 may be a server or circuit in operative communication with the base station where the base station can wirelessly communicate information as described herein. The portable device 12 communicates with a network 22 via a wireless communication link 24, as known in the art. The network 22 may include one or more wireless networks including wireless wide area networks, wireless local area networks, the Internet, intranets, or any other suitable network or networks. The portable device 16 for purposes of illustration only, will be referred to as a same type of portable device 12 that may communicate via a link 28 either directly with portable device 12 via, for example, a short range wireless communication link such as a Bluetooth or any other suitable link and may also utilize a wireless wide area network link 30 to communicate with the network 22 or any other suitable device or devices. However, any suitable communication technique may be employed.

The portable device 12, in this example a wireless portable device, includes a controller 32 that is operative to adjust rendering quality of the device 12 based on a user set application run-time length. Rendering quality can include rendering quality provided by graphics processing circuitry.

As to the quality of rendering, an application for example, can be controlled to provide higher graphics rendering quality features for a user or low quality features for a user. For example, in the context of a 3D game, the game application may be controlled as described herein, to render in a higher resolution mode or use fewer primitives to represent objects depending upon a desired run-length duration setting and remaining battery capacity information. An application may be, for example, a software module or modules executing on one or more processors such as, but not limited to, CPU cores, DSP cores, graphics processing cores or other processors. The controller 32 may be implemented, for example, as a processor executing one or more suitable software modules that cause the processor or processors to carry out the operations described herein. Alternatively, the controller 32 may be implemented as discrete logic in the form of an application specific integrated circuit, or state machines or any other suitable structure or may be implemented by any suitable combination of hardware, software, and firmware as known in the art.

Dynamic rendering quality control may be performed using, for example, a power aware application that is executed by the controller (or other processor) or may be implemented as a driver application executing on a portion of a controller or any processor that interfaces with or contains graphics processing circuitry to perform the graphics rendering. In one embodiment, the runtime length based quality of rendering controller 32 determines battery capacity information and internally controls the quality of rendering using quality of rendering control information as will be described further below. Alternatively, the network element 15 may receive remaining battery capacity information 40 sent by the device 12 and in response thereto sends quality of rendering control information 42 back to the portable device 12 so that the portable device 12 may then carry out the appropriate quality of rendering control. Examples of quality of rendering control may include, for example, having the graphics processing circuitry switch to a lower quality processing pipeline for mipmaps, request lower quality texture so that, for example, one of a plurality of RAM chips or RAM portions that are used by the graphics processing circuit may be powered off since the required lower quality textures can be stored in a smaller RAM space. Other examples may include, for example, unbeknownst to the application, using the driver to cause a drop in visual quality of output images by turning off anti-aliasing or changing the level of detail used by the graphics processing circuitry so that runtime length can be extended. In addition, the graphics processing circuitry can be controlled to reduce the tessellation level used based on the battery capacity level so that as the battery capacity level decreases, the tessellation level may also decrease, thereby reducing power consumption and increasing the run-length time of the application. Other examples will be recognized by those of ordinary skill in the art.

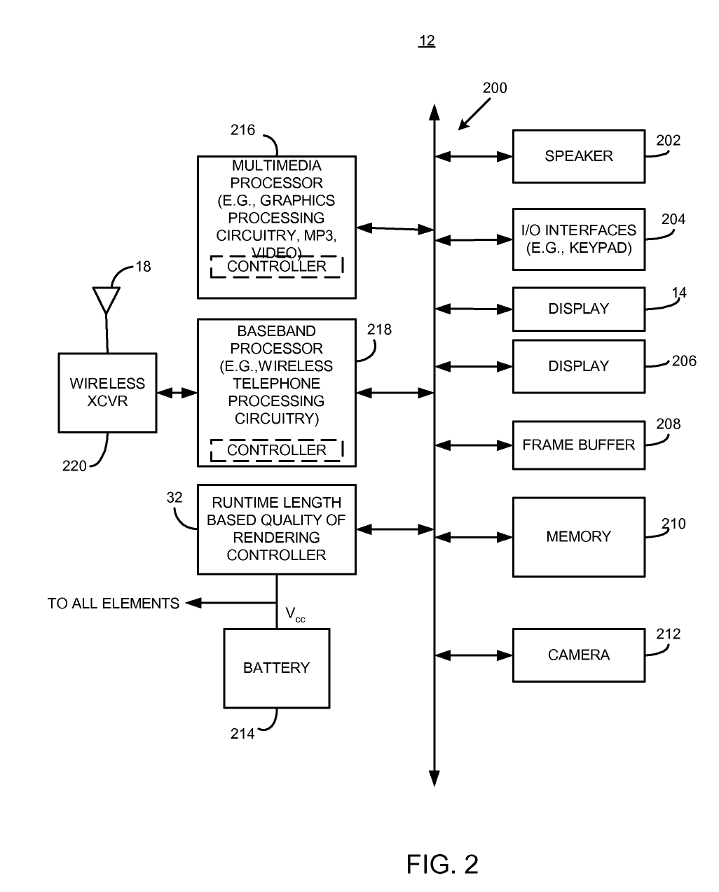

FIG. 2 illustrates a block diagram of one example of the portable device 12, such as a wireless handset device, such as a cell phone or any other suitable device as noted above. As shown, the device 12 may include a communication structure 200 that may include a plurality of buses or other interconnections as desired to allow the various blocks to communicate with one another. The portable device 12, in this example, includes one or more speakers 202, input/output interfaces 204, such as keypads, graphic user interfaces, or any other suitable interfaces, one or more displays, one or more frame buffers 208, memory 210, a camera 212, a battery 214, a multimedia processor 216, a baseband processor 218, a wireless transceiver 220 and the controller 32.

The multimedia processor 216 may be, for example, a multimedia core that is separate from or integrated with the baseband processor 218 or controller 32 as desired. The multimedia processor 216 includes graphics processing circuitry, such as a graphics core, that includes one or more 3D rendering engines as known in the art. It will be recognized that any suitable graphics processing circuitry may be employed such as ATI IMAGEON type graphics processors, sold by ATI Technologies Inc., 1 Commerce Valley Drive, Thornhill, Ontario, or any other suitable graphics processing circuitry that generates graphics information based on primitives and that provides any suitable graphics or video processing as known in the art. The multimedia processor 216 may also include video encoders and decoders as known in the art. It will be recognized that the functional blocks illustrated in FIG. 2 may be incorporated as any suitable structure, such as one or more integrated circuits or other structures as known in the art. The multimedia processor 216 may be, for example, a graphics processing core in combination with audio and video processing circuitry to allow the generation of graphics and/or video for display on one or more displays 14 and 206 and employs the frame buffer 208 to store intermediate data and final data for display as known in the art. As shown, the controller 32 may be incorporated in the multimedia processor or baseband processor or may be a stand alone integrated circuit if desired. The baseband processor 218, as known in the art, suitably processes received signals or signals to be transmitted via wireless transceiver 220 and may include, for example, any necessary wireless telephone processing circuitry to process voice or circuitry to process data information that is received or sent via the wireless transceiver 220. The battery 214 is operatively coupled to the various elements to supply power when the device is operated in a battery mode. As used herein, a battery can include any suitable structure that has a limited power capacity. For example, the battery 214 may be a charged capacitor, fuel cell, lithium based power source or any suitable portable limited power source and may include one or more limited capacity power sources, such as a plurality of discrete power sources that are electrically coupled together, or may take any suitable form as known in the art.

The controller 32 is coupled to the battery 214 and to the graphics processing circuitry (shown in multimedia coprocessor 216) and dynamically controls rendering quality of an output image by controlling the graphics processing circuit when the wireless portable device is in a reduced power mode. This is done based on user settable desired runtime length data as, for example, selected by a user. The processor (controller 32) in one embodiment, also executes the application whose runtime length has been selected.

The frame buffer 208 may be employed in memory 210 or other memory and may take any suitable form and may be included, for example, in the multimedia processor 216 or as part of any other module as desired. The frame buffer 208 and memory 210 may take any suitable form including, but not limited to, ROM, RAM, optical storage structures, or any suitable digital storage medium. The memory 210, or any other suitable memory, may contain the executable instructions that when executed cause the controller or any processing device to operate as indicated herein. It will be recognized that the blocks shown in the figure are meant to show functional blocks and may be suitably incorporated and combined as desired. As such, the memory may include suitable registers or the processors may include the registers or any suitable structure may be used as understood in the art. As known in the art, the camera 212 may be any suitable image providing circuit including a camcorder or any other suitable structure that provides an image to, for example, the multimedia processor 216 for processing and display on one or more displays 14 and 206 as known in the art. It will be recognized that the functional blocks shown in FIG. 2 are merely examples and that any suitable functions may be employed in a portable device as known in the art.

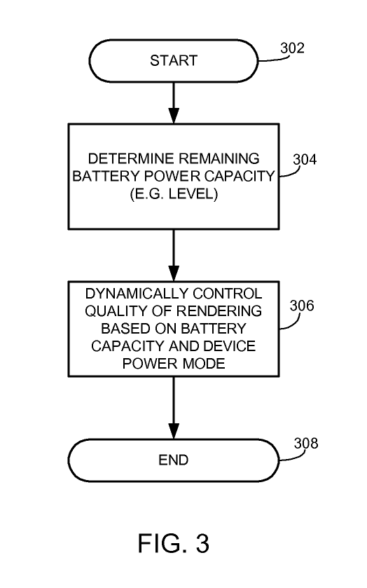

FIG. 3 illustrates one example of a method for dynamically controlling a rendering quality of graphics circuitry implemented using one or more of the blocks shown in FIG. 2. In addition, any other suitable element including the network element 15 remote from the device 12 may perform any desired operations described herein. It will also be recognized that the order of operations of the methods described herein may be suitably changed as recognized by one of ordinary skill in the art depending upon a desired outcome. As shown, the method starts in block 302 when the wireless portable device 12 has power and is in an “on” state. In block 304, the method includes determining a remaining battery power capacity of a battery of the device. This includes obtaining, for example, a battery power capacity value from a register or other storage location that was stored by another software module that (repeatedly, for example) determines the remaining battery power capacity or determining may include receiving the remaining battery capacity information from the network element or from another process or circuit within the device. Alternatively, this may also include calculating the remaining battery power capacity based on, for example, a current voltage level of the battery and/or obtaining data that represents past or expected future battery performance information, or by any other suitable manner. As shown in block 306, the method includes dynamically controlling the quality of rendering of an image that is displayed (including moving video images or any other images) based on the battery capacity and based on the device power mode. For example, if the device is in a low power mode, the quality of rendering is controlled to be consistent with the remaining battery capacity and the designated runtime as set, for example, by a default value or through a user interface. The dynamic control may be continuous and repeated multiple times per second if desired or with any other suitable frequency. As shown in block 308, the method may end when desired or may repeat as needed. The battery capacity information may be obtained, for example, by the controller 32 or from any other suitable battery capacity detection or determination circuit or may be stored in a register or any other memory location. The battery capacity information may be, for example, information representing how much remaining power—also referred to as remaining energy level is available from the battery at a given point in time. The battery capacity information may also include information indicating the remaining battery capacity in terms of ampere hours or the amount of power (Joules of energy or other representation) per unit time such as a number of microwatts that are available per unit time given a current or expected operating load of the device. Adjusting quality of rendering may be performed, for example, by the controller 32 or any other suitable element.

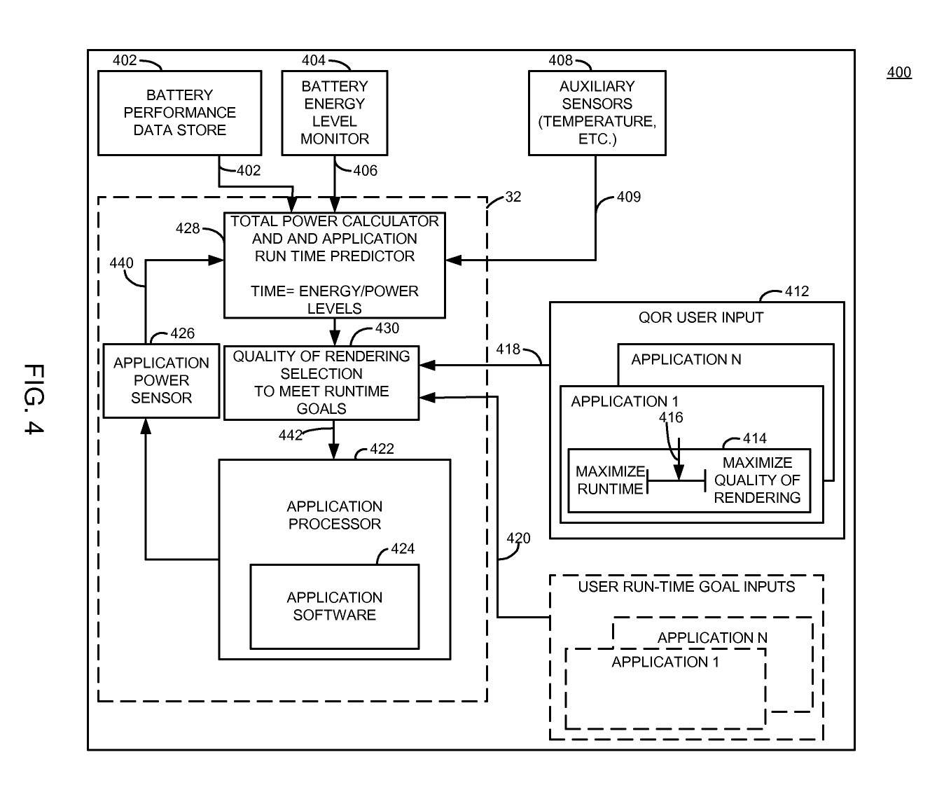

FIG. 4 is a block diagram illustrating the controller 32 in an application level power management system 400. The system 400 may be within the portable device 12 and in this example, includes memory containing battery performance data 402, a battery energy level monitor 404, and auxiliary sensors such as temperature sensors 408 that provide temperature information 409 to the controller 32. The battery performance data 402 may be historical data of the battery capacity consumed by a particular application using particular operating parameters (e.g., processor clock and supply voltage control, other applications running, or any other suitable parameters) for a relevant unit (e.g., such as a per unit of game runtime). In this example, the battery performance data 402 may be an array of stored data with multiple entries that could be pre-populated and then updated over time of actual usage information as a particular game or application is utilized. The manufacturer can provide this information as well (e.g., performance vs. loading and versus battery age). The system then keeps track of loading levels and battery age. The battery performance degrades over time, and battery management systems (e.g., in laptop computers) keep track of how often a battery is discharged and charged, and maintain an updated amp*hours (or capacity) rating. A graphic user interface 412 is shown which allows a user to select on a per application basis for example, whether the controller should control features to allow the maximum application runtime that the user desires or a maximum quality of rendering that the graphics processing circuitry or application provides or any suitable level therebetween. The graphic 414 presented on a display provides selectable application runtime information 416 within a range of the controller providing a maximum quality of rendering level by the application up through a maximum application run-length time. The desired application quality of rendering information 418 is selected by the user in this example but may be a default value if desired and is provided to the controller. Alternatively, the user specified runtime length for each application may be provided as shown as data 420 as selected through a suitable graphic user interface or other suitable interface. In this example, the controller 32 is a suitably programmed processor or set of processors that include, for example, an application processing portion 422 that executes the application software 424 such as a game, or any other suitable code. The controller 32 also includes an application power sensor module 426 that may be for example, software executed by the controller 32 in addition to a total power calculator and application runtime predictor module 428 and quality of rendering selector 430 both of which may be implemented as software modules executed by the controller 32.

The battery energy level monitor 404 monitors the present battery voltage level and provides a current battery level 406 which may then be used by the total power calculator and application runtime predictor 428 to determine how much battery capacity the battery can currently provide by, for example, using the battery level 406 to look up the corresponding energy that the battery can provide. It will be recognized, however, that any other suitable technique may be used to determine the battery capacity information. The battery capacity information may be used to determine how to control various graphics based operations as further described below. The application power sensor 426 may be, for example, a current sense circuit or voltage sense circuit for the application processor 422 to determine how much power is being consumed when executing the application software 424. The application power usage information 440 is also provided to the total power calculator and application runtime predictor 428. The total power calculator and application runtime predictor 428 determines the amount of time, for example, that the current application 424 can be run at its current level based on the current amount of power usage 440, and the battery capacity information. The total power calculator and application runtime predictor 428 then predicts the runtime length of the application and selects a suitable quality of rendering to meet the runtime goal information 418 set by the user. The quality of rendering selection then determines whether the application processor 422 needs to dynamically control the processing by the application processor of the application software 424 by providing, for example, control information 442 for the graphics processing circuitry. The auxiliary sensor information 409 may be used to better predict remaining battery capacity. For example, if the temperature of the device or controller is high, more leakage and more power consumption may occur.

The total power calculator and application runtime predictor 428 serves as a battery capacity determinator and generates battery capacity information for use in determining the estimated runtime that can be provided by the current battery capacity provided by the current battery capacity, and by the current battery loading. The total power calculator and application runtime predictor 428 estimates how much time a given application will operate for under a given operating condition.

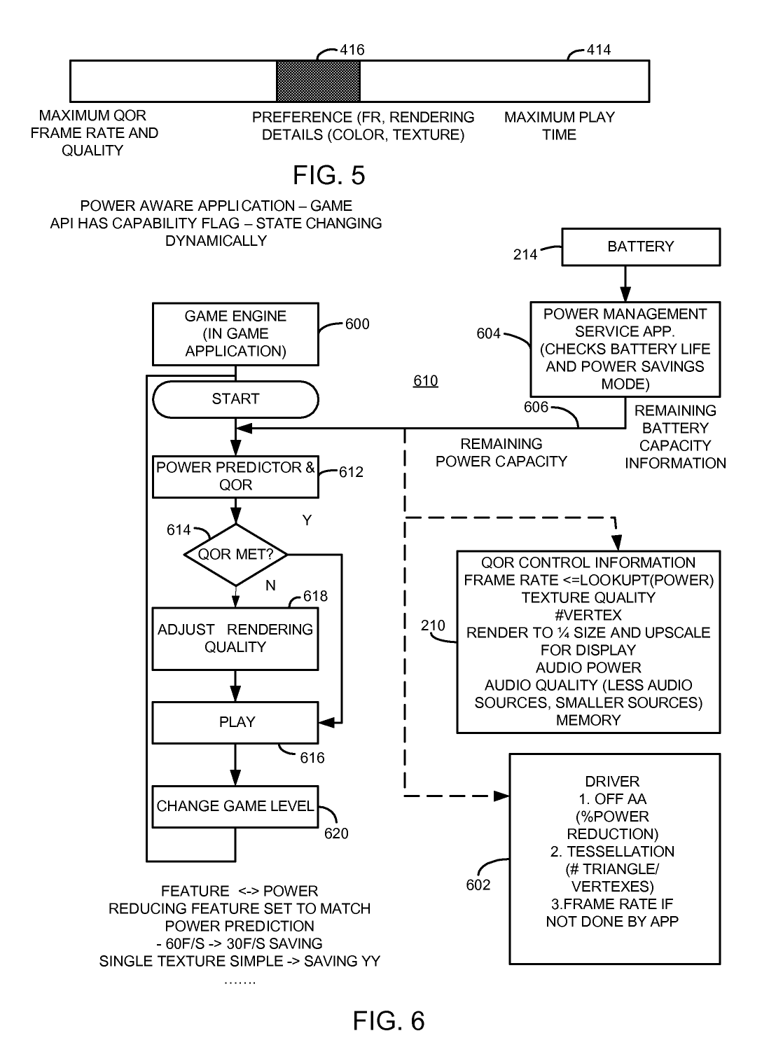

FIG. 5 illustrates an example of the graphic user interface having a graphic 414. The user interface provides a selectable desired application run-time duration as compared to a desired quality of rendering level and provides selected (e.g., as selected by a position on the graphic) application run-time duration information to a controller. At one end of the graphic 414, a user can select a maximum quality of rendering control wherein the highest quality of graphics rendering will be provided for a given application or applications. On the other extreme, the user may select as the application runtime information 416, the maximum runtime for the application which results in the lowest quality of rendering being provided, to conserve power during a low power mode. Other user interface controls known to those of ordinary skill in the art (e.g., buttons, numeric entries, drop down lists, check boxes, etc.) could be employed to provide both different types of user interfaces and differing degrees of control (e.g., basic types of user interface controls for “basic” or novice users and more advanced types of user interface controls for more “advanced” or sophisticated users).

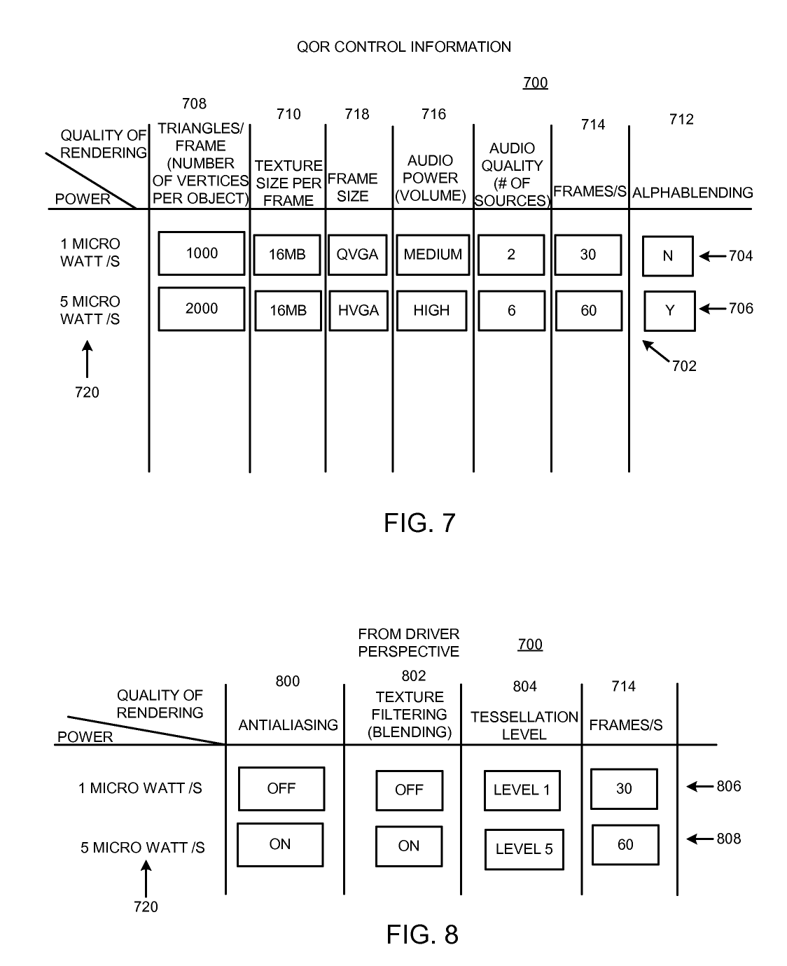

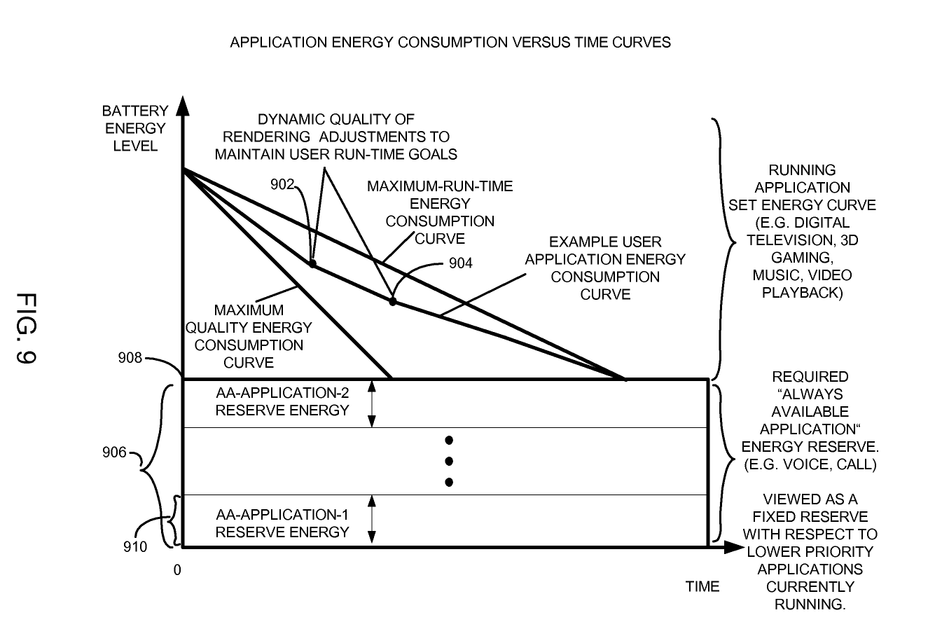

The user may set the quality of rendering levels on a per application basis or any suitable basis. This may include selecting a given application for a maximum available runtime or to instead maximize the quality of rendering irrespective of the amount of power it may consume. As such, the graphic user interface 412 is used to receive the user input runtime length information. In one embodiment, a lookup table (in memory) stores multiple quality of rendering levels that have corresponding rendering control information for different quality of rendering levels on a per application basis or other suitable basis. The selected runtime information designates a quality of rendering level. The corresponding graphics rendering control data may include, for example, the number of primitives used to render an object or other controllable features of graphics processing cores (see FIGS. 7 and 8). Any other suitable rendering control information may be used to reduce or increase the available runtime for a given application.

FIG. 6 is a flowchart illustrating one example of a method for runtime based rendering quality control in accordance with one embodiment of the invention. The flowchart and functional block diagram illustrates the operation, for example, of the controller 32 in two embodiments. In a first embodiment, a game engine 600 such as a code or code segments of a game application determines whether to adjust rendering quality and executes different executable code segments to change the quality of rendering based on remaining battery capacity information. One code segment may cause the graphics processing circuitry to render information differently than another code segment to conserve power. In another example, a driver application may be used instead to interface with existing game applications that are not power aware applications and instead employ, for example, driver code 602 that executes on the controller 32 that adjusts the quality of rendering and determines whether or not an adjustment needs to be made. The controller 32 utilizes a power management module (e.g., an executing application) 604 that includes the total power calculator and application runtime predictor 428 shown in FIG. 4. The power management service module 604 checks the battery life for a given power savings mode to determine the battery capacity level or battery capacity information 606 based on the level of the battery 214.

Also referring to FIG. 7, memory 210 contains data representing quality of rendering control information 700 that is used to control graphics processing circuitry to change a quality of graphics rendering based on the quality of rendering control information 700. The quality control information 700 may be in the form of a lookup table or in any other suitable form and includes graphics rendering control information 702 for different quality of rendering levels 704. As shown, a 1 microwatt per second power usage level may utilize a quality of rendering level that may set the number of primitives per frame, such as the number of vertices per object to, for example, 1,000, set the texture size per frame to 16 megabytes, set audio power volume level to a medium level, set the output frame rate to 30 frames per second and shut off alpha blending as shown. A different quality of rendering level 706 is associated with a different power usage level shown as 5 microwatts.

As noted above, the controller 32 dynamically controls rendering quality of an output image that is displayed on a display when the device is in a reduced power mode based on a desired runtime length of an application. The power management module 604 determines which power mode the device is in and the amount of battery capacity remaining.

The quality of rendering control information 700 includes data representing a number of vertices per object to use for rendering objects 708, a texture size to use per frame 710, a degree of anti-aliasing to employ or a type of anti-aliasing technique to employ, whether to use alpha blending 712, a tessellation level to employ, a playback frame rate 714, and audio power level to utilize 716 and the frame size to use for display as shown as 718. However, it will be recognized that any quality of rendering control information may also be employed. Power consumption rate information 720 indicates the amount of power use per second when the quality of rendering control information is set as shown. In this way, the amount of energy use over time can be predicted for a given quality of rendering level.

Referring back to FIG. 6, the quality of rendering control information 700 may be used by the game engine 600 that carries out the method shown generally as method 610. The game application 424, for example, obtains the remaining power capacity information 606 from the power management module 604 and as shown in block 612, predicts the amount of power that will be used at a given quality of rendering level as obtained from the quality of rendering control information 700. As shown in block 614, the method includes determining if the desired quality of rendering level is met by the predicted power used. The quality of rendering that is desired corresponds to the desired application runtime duration that was selected by the user. For example, if the user indicated that the user wanted the maximum runtime, then the quality of rendering level would be at the lowest level which uses the lowest power and would be at quality of rendering level 704, for example. If the quality of rendering that is desired can be met by the amount of power used for a given level that the application is currently running at, the application will play the game and continue to operate in the same manner as shown in block 616. However, if the quality of rendering level cannot be met, then the game executes a different code segment that sends different graphics rendering commands to the graphics processing circuitry to adjust the rendering quality as shown in block 618. If power levels drop too low, even with a lowest QoR, the method includes halting the process and maintaining reserve energy for higher priority applications like emergency voice calls in the case of the device being a cell phone. As shown by block 620, when changes occur in game scenery that are significant (e.g. switch to a new level), then the QoR targets may have to change, and new parameters may need to be optimized. Ideally the game would provide hints so QoR is adjusted at the right time for the system to optimize visual appeal of each scene. Alternatively, every ‘N’ milliseconds, one could repeat the loop and compute new QoR settings, in a way that is more game independent. However, having the game support QoR reduction natively is the best solution and may allow one to reach lower power levels. Memory 210 may store the application software 624 and any other executable instructions that when executed, cause the controller to operate as described herein. As such, the memory 210 as noted above, may be RAM, ROM, distributed memory such as memory in web server accessible, for example, via the Internet, or any other suitable digital storage medium.

The user interface 412 provides a selectable desired application runtime duration, such as through graphic 414 or any other mechanism during a low power mode and the controller 32 uses the quality of rendering control information 700 from memory to dynamically control the rendering quality based on the selected desired application runtime duration which is used by the game engine in this example. The controller 32, through the method 610 for example, predicts an amount of energy that the application will consume and controls the quality of rendering to match the desired runtime length of the application. In some embodiments, it may be desirable to switch from a first level of rendering quality when the remaining battery capacity is at a first level to a second level of rendering quality when the remaining battery capacity reaches a threshold. For example, a user may desire to have the maximum (e.g., best) level of rendering quality when the battery is at or near its maximum charge capacity. However, when the battery capacity drops below a threshold, say 50%, (this threshold may, in some embodiments, be set through user interface controls by the user), the level of rendering quality would be reduced to a second and lower rendering quality. In this manner, the user experiences the best level of rendering when the battery is or nearly fully charged but then is enabled to enjoy more game play, for example, but at lower rendering quality, once the battery becomes nearly depleted. Thus the user is enabled to play for longer than would be the case if the rendering quality remained constant during game play as the battery discharged.

In another embodiment, where a driver 602 is employed instead of a power aware game application, the driver 602 performs similar operations as the game engine 600 but instead does not cause different game application code segments to be executed. Instead, the driver 602 causes the controller 32 to send the appropriate commands to the graphics processing circuit, as known in the art, to render graphics information using the quality of rendering control information 700.

Referring also to FIG. 8, from the perspective of the driver 602, the quality of rendering control information 700 may include data representing, for example, whether to employ anti-aliasing and therefore includes anti-aliasing control information 800, whether texture filtering should be applied indicated by data 802, the level of tessellation to be applied by tessellation level information 804, or any other suitable information. In this example, different quality of rendering control information 700 may be employed for different quality of rendering levels 806 and 808.

FIG. 9 illustrates an application energy consumption versus time curve diagram of the device 12 at set thresholds 902 and 904, such as the application runtime information 416 (see FIG. 4). If desired, in another embodiment, the reserve battery energy level 906 may be used, for example, for voice calls or other applications. The available energy above this level may be used for playing games, other applications or device features that employ graphics rendering. However, once the battery energy level 908 is met, the controller 32 does not allow certain applications to be executed but instead may only allow a voice mode to be activated. Within the battery level range 906 are further priorities of applications and for example, an emergency call level 910 may be the highest priority level in that no other applications are allowed to run once this battery capacity level has been reached to allow the device at least to be used for emergency calls for safety reasons. However, it will be recognized that the device 12 may be configured so that any suitable application or feature may serve as the highest priority feature, such as a game application if desired.

Among other advantages, the quality of rendering may be controlled based on the desired runtime length of one or more applications wherein the quality of rendering may be suitably adjusted in an attempt to meet the set runtime length of an application during a low power mode. Other advantages will be recognized by one of ordinary skill in the art.

The above detailed description of the invention and the examples described therein have been presented for the purposes of illustration and description only and not by limitation. It is therefore contemplated that the present invention cover any and all modifications, variations or equivalents that fall within the spirit and scope of the basic underlying principles disclosed above and claimed herein.

What is claimed is:

1. A device comprising:
a controller operative to dynamically control rendering quality of an output image when the device is in a reduced power mode based on data representing a desired run-time length of an application.

2. The wireless portable device of claim 1 comprising memory containing data representing quality of rendering control information and wherein the controller controls graphics processing circuitry to change a quality of graphics rendering based on the data representing quality of rendering control information.

3. The wireless portable device of claim 2 wherein the data representing quality of rendering control information comprises at least one of: data representing a number of vertices per object to use for rendering objects, a texture size to use per frame, degree or type of anti-aliasing to employ, whether to use alpha blending, a tessellation level to employ, and playback frame rate.

4. The wireless portable device of claim 1 comprising a user interface operative to provide a selectable desired application run-time duration during low power mode and wherein the controller uses quality of rendering control information from memory to dynamically control the rendering quality based on a selected desired application run-time duration.

5. The wireless portable device of claim 1 wherein the controller comprises a plurality of executable code segments of the application that are alternatively executed to change a quality of rendering based on remaining battery capacity information.

6. The wireless portable device of claim 5 comprising a battery and a power management module operative to provide remaining battery capacity information to the application based on a remaining battery capacity and a power savings mode of the device.

7. The wireless portable device of claim 1 wherein the controller is operative to predict an amount of power that the application will consume and is operative to control the quality of rendering to match the desired run-time length of the application.

8. A wireless portable device comprising:
a graphics processing circuit; and
a processor, operatively coupled to the graphics processing circuit, and operative to dynamically control rendering quality of an output image by controlling the graphics processing circuit when the wireless portable device is in a reduced power mode based on data representing user settable desired run-time length of an application, the processor also executing the application.

9. The wireless portable device of claim 8 wherein the application comprises executable instructions that when executed by the processor cause the processor to predict an amount of power that the application will consume and is operative to control the a quality of rendering to match the desired run-time length of the application by executing a plurality of executable code segments of the application that are alternatively executed to change a quality of rendering based on remaining battery capacity information.

10. The wireless portable device of claim 8 comprising memory containing data representing quality of rendering control information and wherein the processor executes driver code that when executed controls graphics processing circuitry to change a quality of graphics rendering based on the data representing quality of rendering control information.

11. The wireless portable device of claim 10 wherein the data representing quality of rendering control information comprises least one of: data representing a number of vertices per object to use for rendering objects, a texture size to use per frame, degree or type of anti-aliasing to employ, whether to use alpha blending, a tessellation level to employ, and playback frame rate.

12. The wireless portable device of claim 9 wherein the processor comprises a power management module operative to provide the remaining battery capacity information to the application based on a remaining battery capacity and a power savings mode of the device.

13. The wireless portable device of claim 1 wherein the processor is operative to predict an amount of power that the application will consume and is operative to control the a quality of rendering, using the graphics processing circuitry, to match the desired run-time length of the application.

14. The wireless portable device of claim 8 comprising a user interface operative to provide a selectable desired application run-time duration during low power mode and wherein the controller uses quality of rendering control information from memory to dynamically control the rendering quality based on a selected desired application run-time duration.

15. A method comprising:
determining an amount of remaining battery capacity in a portable device; and
dynamically controlling rendering quality of an output image when the portable device is in a reduced power mode based on data representing a desired run-time length of an application.

16. The method of claim 15 wherein determining an amount of remaining battery capacity comprises receiving and/or obtaining data representing an amount of remaining battery capacity.

17. The method of claim 15 comprising controlling graphics processing circuitry to change a quality of graphics rendering based on data representing quality of rendering control information.

18. The method of claim 15 wherein the data representing quality of rendering control information comprises at least one of: data representing a number of vertices per object to use for rendering objects, a texture size to use per frame, degree or type of anti-aliasing to employ, whether to use alpha blending, a tessellation level to employ, and playback frame rate.

19. The method of claim 15 comprising providing a selectable desired application run-time duration during low power mode and using quality of rendering control information to dynamically control the rendering quality based on a selected desired application run-time duration.

20. The method of claim 15 comprising providing remaining battery capacity information based on a remaining battery capacity and a power savings mode of the device.

21. The method of claim 15 comprising predicting an amount of power that the device will consume and controlling the quality of rendering to match the desired run-time length of the application.

22. A digital storage medium comprising executable instructions that when executed causes one or more processors to:
determine an amount of remaining battery capacity in a portable device; and
dynamically control rendering quality of an output image when the portable device is in a reduced power mode based on data representing a desired run-time length of an application during low power mode.

23. The digital storage medium of claim 22 comprising executable instructions that when executed causes the one or more processors to control graphics processing circuitry to change a quality of graphics rendering based on data representing quality of rendering control information.

24. The digital storage medium of claim 22 wherein the data representing quality of rendering control information comprises least one of: data representing a number of vertices per object to use for rendering objects, a texture size to use per frame, degree or type of anti-aliasing to employ, whether to use alpha blending, a tessellation level to employ, and playback frame rate.

25. The digital storage medium of claim 22 comprising executable instructions that when executed causes the one or more processors to provide a selectable desired application run-time duration during low power mode and using quality of rendering control information to dynamically control the rendering quality based on a selected desired application run-time duration.

26. The digital storage medium of claim 22 comprising executable instructions that when executed causes the one or more processors to provide remaining battery capacity information based on a remaining battery capacity and a power savings mode of the device.

27. The digital storage medium of claim 22 comprising executable instructions that when executed causes the one or more processors to predict an amount of power that the device will consume and controlling the a quality of rendering to match the desired run-time length of the application.

28. A network element comprising:
memory containing data representing quality of rendering control information; and
a network interface operatively coupled to the memory and operative to send the quality of rendering control information to a wireless portable device.

29. The network element of claim 28, wherein the network element is operative to receive a battery capacity level of a remote wireless device and is operative to send the quality of rendering control information in response to the received battery capacity information.

30. A device comprising:
a user interface operative to provide a selectable desired application run-time duration as compared to a desired quality of rendering level and to provide selected application run-time duration information to a controller.

31. The device of claim 30 wherein the user interface provides a selectable quality of rendering setting for a low power mode of the device.

32. The device of claim 30 wherein the user interface is a graphic user interface on a display.
